(19) United States
(12) Patent Application Publication
(10) Pub. No.: US 2026/0230703 A1
(43) Pub. Date: Aug. 6, 2026

(54) LENS DRIVE SYSTEM AND PORTABLE DEVICE

(71) Applicant: Asahi Kasei Microdevices Corporation, Tokyo (JP)

(72) Inventors: Ryota Sakamoto, Tokyo (JP); Ryuta Imashioya, Tokyo (JP)

(73) Assignee: Asahi Kasei Microdevices Corporation, Tokyo (JP)

(21) Appl. No.: 19/457,091

(22) Filed: Jan. 22, 2026

(30) Foreign Application Priority Data
Jan. 24, 2025 (JP) 2025-010309
Jan. 21, 2026 (JP) 2026-008486

(51) Int. Cl. H04N 23/65; G02B 27/64; G03B 5/00; H04N 23/68

(52) U.S. Cl. CPC H04N 23/651; G02B 27/646; G03B 5/00; H04N 23/687; G03B 2205/0007

(57) ABSTRACT

A lens drive system that controls a relative position of a lens with respect to an image sensor includes multiple lens drive devices provided corresponding to multiple lenses and each controlling the relative position of a corresponding lens. Each of the image sensors outputs detection data, the detection data of which of the image sensors is used to generate image data is controlled according to status information of a camera device, and a signal processing unit of at least one of the lens drive devices changes power consumption of a position detection unit according to the status information.

### CROSS-REFERENCE TO RELATED APPLICATION

This application claims the priority benefits of Japanese application no. 2025-010309, filed on January 24, 2025, and Japanese application no. 2026-008486, filed on January 21, 2026. The entirety of each of the above-mentioned patent applications is hereby incorporated by reference herein and made a part of this specification.

### BACKGROUND

### Technical Field

The disclosure relates to a lens drive system and a portable device.

### Description of Related Art

Patent Document 1 (U.S. Patent Application Publication No. 2022/0182546) discloses a method for controlling multiple cameras mounted on a portable device.

### SUMMARY

In a first aspect of the disclosure, a lens drive system is provided that controls a relative position of a lens with respect to an image sensor for multiple lenses provided corresponding to multiple image sensors in a camera device. The lens drive system may include multiple lens drive devices provided corresponding to the lenses, and each controlling the relative position of the corresponding lens. In any of the above lens drive systems, each of the lens drive devices may have a position detection unit that detects the current relative position of the corresponding lens. In any of the above lens drive systems, each of the lens drive devices may have a calculation unit that calculates a drive amount of at least one of the lens and the image sensor based on a current position signal that is an output of the position detection unit and an input target position signal. In any of the above lens drive systems, each of the lens drive devices may have a drive unit that drives at least one of the lens and the image sensor based on the drive amount. In any of the above lens drive systems, each of the lens drive devices may have a signal processing unit that outputs a power control signal for controlling power consumption of the position detection unit. In any of the above lens drive systems, each of the image sensors may output detection data, and the detection data of which of the image sensors is used to generate image data may be controlled according to status information of the camera device. In any of the above lens drive systems, the signal processing unit of at least one of the lens drive devices may change the power consumption of the position detection unit according to the status information of the camera device. At this time, a communication path of the lens drive device may be in an active state.

In any of the above lens drive systems, the signal processing unit may reduce the power consumption of the corresponding position detection unit to be smaller than the power consumption of the rest of the position detection units according to the status information. At this time, the drive unit may be operated to be in a state capable of generating image data.

In any of the above lens drive systems, in the case of the signal processing unit reducing the power consumption of the corresponding position detection unit to be smaller than the power consumption of the rest of the position detection units, the power consumption of the corresponding drive unit may be maintained. At this time, image data may be generated by the image sensor by performing an image stabilization operation through controlling the lens position by the drive device.

In any of the above lens drive systems, in the case of the signal processing unit reducing the power consumption of the corresponding position detection unit to be smaller than the power consumption of the rest of the position detection units, the power consumption of the corresponding drive unit may be reduced. At this time, image data may be generated by the image sensor by performing an image stabilization operation through controlling the lens position by the drive device.

In any of the above lens drive systems, the signal processing unit may reduce the power consumption of the position detection unit by reducing the total time during which the position detection unit operates to output the current position signal within a unit time.

In any of the above lens drive systems, the signal processing unit may reduce the power consumption of the position detection unit by increasing a rest period during which the position detection unit does not perform an operation for outputting the current position signal within a unit time.

In any of the above lens drive systems, the signal processing unit may reduce the power consumption of the position detection unit by shortening a conversion period during which the position detection unit operates to output the current position signal of one time.

In any of the above lens drive systems, the lens drive devices may include a first lens drive device and a second lens drive device that control the relative position of a common lens. In any of the above lens drive systems, in response to the status information, the power consumption of one of the first lens drive device and the second lens drive device may be controlled to be smaller than the power consumption of the other.

In any of the above lens drive systems, the position detection unit may be capable of a continuous operation in which conversion periods during which the position detection unit operates to output the current position signal are continuous, and an intermittent operation in which a rest period during which the position detection unit does not operate to output the current position signal and the conversion period are repeated. In any of the above lens drive systems, the signal processing unit may reduce the power consumption by causing the position detection unit to perform the intermittent operation.

In any of the above lens drive systems, a repetition period obtained by adding the conversion period of one time and the rest period of one time in the intermittent operation may be equal to or less than a period for outputting the current position signal of one time in the continuous operation.

In any of the above lens drive systems, the signal processing unit may adjust at least one of the conversion period and the rest period so that a repetition frequency at which the conversion period and the rest period are repeated in the intermittent operation is equal to or higher than a preset set frequency.

In any of the above lens drive systems, the set frequency may be equal to or higher than an upper limit of an audible frequency.

In any of the above lens drive systems, the set frequency may be 10 kHz or higher.

In any of the above lens drive systems, the position detection unit may have a position sensor that detects the relative position. In any of the above lens drive systems, the position detection unit may have an analog-to-digital (AD) converter that converts the relative position into digital data. In any of the above lens drive systems, when operating the position detection unit in the intermittent operation, the signal processing unit may lower an oversampling ratio of the AD converter and increase an output rate compared to the case of the continuous operation. Alternatively, although the oversampling ratio of the AD converter is lowered, the output rate may be maintained by providing the rest period of the AD converter.

In any of the above lens drive systems, when operating the position detection unit in the intermittent operation, the signal processing unit may lower resolution of the AD converter and increase an output rate compared to the case of the continuous operation. Alternatively, although the oversampling ratio of the AD converter is lowered, the output rate may be maintained by providing the rest period of the AD converter.

In any of the above lens drive systems, the position detection unit may have a position sensor that detects the relative position and outputs a differential detection signal. In any of the above lens drive systems, the position detection unit may have a chopper modulator that modulates a polarity of the differential detection signal according to a chopping frequency. In any of the above lens drive systems, the position detection unit may have a differential amplifier that amplifies and outputs an output of the chopper modulator. In any of the above lens drive systems, the position detection unit may have a chopper demodulator that demodulates an output of the differential amplifier according to the chopping frequency. In any of the above lens drive systems, the position detection unit may have an AD converter that converts the detection signal output by the chopper demodulator into digital data. In any of the above lens drive systems, the signal processing unit may control an output rate of the AD converter to control power consumption of the position detection unit. In any of the above lens drive systems, a variation amount of the chopping frequency before and after the output rate of the AD converter varies may be smaller than a variation amount of the output rate.

In any of the above lens drive systems, the chopping frequency may be maintained constant before and after the output rate of the AD converter varies.

In any of the above lens drive systems, a repetition frequency at which the conversion period and the rest period are repeated in the intermittent operation may be equal to or higher than a calculation frequency at which the calculation unit calculates the lens drive amount.

In any of the above lens drive systems, the position detection unit may have a high-speed intermittent mode in which a repetition frequency at which the conversion period and the rest period are repeated in the intermittent operation is equal to or higher than an audible frequency, and a low-speed intermittent mode in which the repetition frequency is smaller than the audible frequency. In any of the above lens drive systems, the signal processing unit may switch between the high-speed intermittent mode and the low-speed intermittent mode according to an external signal.

In a second aspect of the disclosure, a portable device provided with a camera device is provided. In the above portable device, the camera device may include multiple image sensors. In any of the above portable devices, the camera device may include multiple lenses provided corresponding to the image sensors. In any of the above portable devices, the camera device may include a lens drive system that controls a relative position of a lens with respect to an image sensor. In any of the above portable devices, the lens drive system may include multiple lens drive devices provided corresponding to the lenses and each controlling the relative position of the corresponding lens. In any of the above portable devices, each of the lens drive devices may have a position detection unit that detects a current relative position of the corresponding lens. In any of the above portable devices, each of the lens drive devices may have a calculation unit that calculates a drive amount of at least one of the lens and the image sensor based on a current position signal that is an output of the position detection unit and an input target position signal. In any of the above portable devices, each of the lens drive devices may have a drive unit that drives at least one of the lens and the image sensor based on the drive amount. In any of the above portable devices, each of the lens drive devices may have a signal processing unit that outputs a power control signal that controls power consumption of the position detection unit. In any of the above portable devices, each of the image sensors outputs detection data, and the detection data of which of the image sensors is used to generate image data may be controlled according to status information of the camera device. In any of the above portable devices, the signal processing unit of at least one of the lens drive devices may change the power consumption of the position detection unit according to the status information.

Any of the above portable devices may include a central control unit that controls each of the signal processing units based on the status information.

Note that the above summary of the disclosure does not enumerate all of the features of the disclosure. Moreover, sub-combinations of the feature groups may also constitute inventions.

### BRIEF DESCRIPTION OF THE DRAWINGS

FIG. 1 is a diagram showing a configuration example of a portable device 200 according to an embodiment of the disclosure.

FIG. 2 is a diagram showing a configuration example of a camera device 100.

FIG. 3 is a diagram showing a configuration example of a lens drive device 120.

FIG. 4 is a diagram showing an operation example of a position detection unit 130.

FIG. 5 is a diagram showing another operation example of the position detection unit 130.

FIG. 6 is a diagram showing another operation example of the position detection unit 130.

FIG. 7 is a diagram showing a control example of the position detection unit 130.

FIG. 8 is a diagram showing another configuration example of the position detection unit 130.

FIG. 9 is a diagram showing a configuration example of a chopper modulator 133, an amplifier 134, and a chopper demodulator 135.

FIG. 10 is a diagram showing an example of time waveforms of differential signals (Vampout, -Vampout) and a frequency spectrum.

FIG. 11 is a diagram showing an example of time waveforms of detection signals (Vout, -Vout) and a frequency spectrum.

FIG. 12 is a diagram showing frequency characteristics of the AD converter 136 and a chopping frequency when the output rate of the AD converter 136 is high speed or low speed.

FIG. 13 is a diagram showing another configuration example of a camera module 110.

### DESCRIPTION OF THE EMBODIMENTS

Hereinafter, the disclosure is described through embodiments of the invention, but the following embodiments do not limit the invention according to the claims. Moreover, not all combinations of features described in the embodiments are required to the solution of the invention.

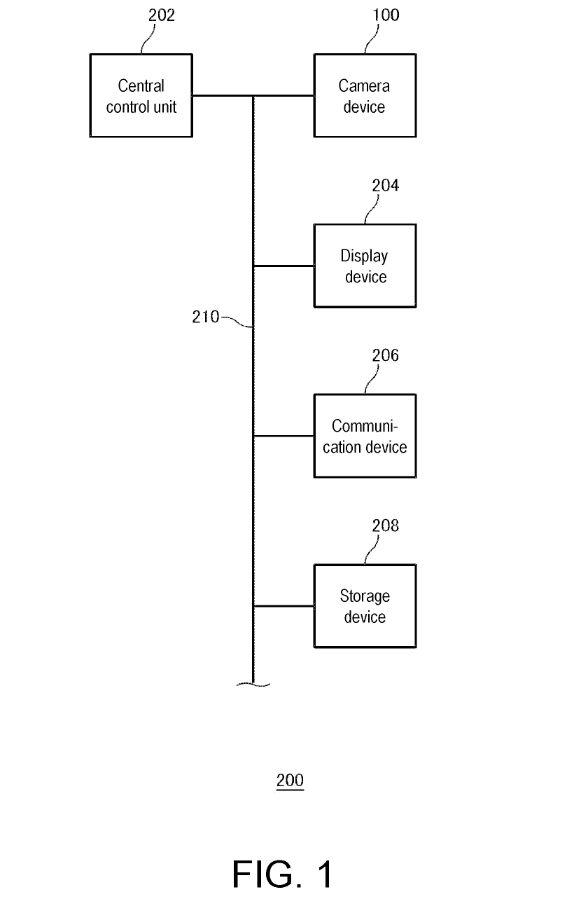

FIG. 1 is a diagram showing a configuration example of a portable device 200 according to an embodiment of the disclosure. The portable device 200 includes a camera device 100. The portable device 200 may be an imaging device, or may be a terminal such as a mobile phone. The portable device 200 of the example may further include at least one of a central control unit 202, a display device 204, a communication device 206, a communication path 210, and a storage device 208.

The central control unit 202 controls each of components of the portable device 200, such as the camera device 100. The central control unit 202 is, for example, a processor such as a CPU. The central control unit 202 communicates with each of the components of the portable device 200 via the communication path 210 by, for example, a serial communication method, a parallel communication method, a network, or a wireless communication method. A signal transmitted by the central control unit 202 may be in an Inter-Integrated Circuit (I2C) method.

The display device 204 displays images. The display device 204 may display images captured by the camera device 100, or may display other images. The communication device 206 communicates with external devices of the portable device 200 by wireless or other means. The communication device 206 may perform voice communication, or may perform data communication including data other than voice. The storage device 208 stores information. The storage device 208 may store image data output by the camera device 100, or may store other data.

The camera device 100 captures images and generates image data. The camera device 100 may have multiple camera modules. Each of the camera modules may have a lens and an image sensor. For example, the camera device 100 may switch the camera module used for generating image data according to the imaging magnification.

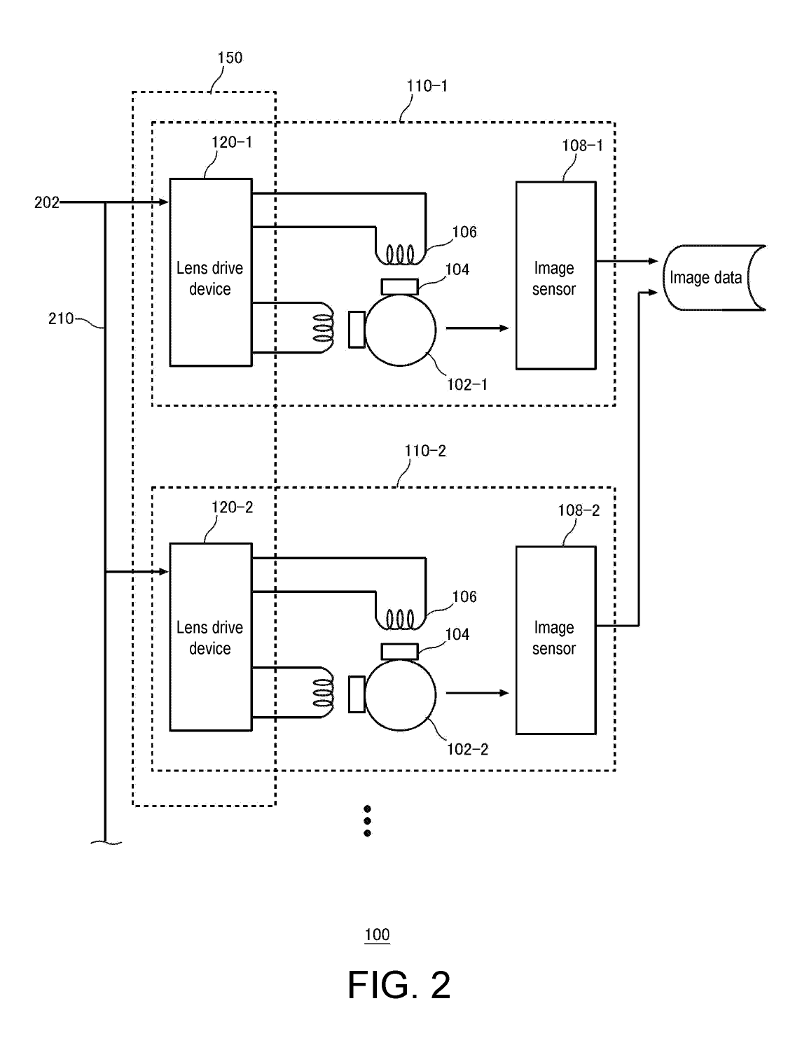

FIG. 2 is a diagram showing a configuration example of the camera device 100. The camera device 100 of the example includes multiple camera modules 110. In the example of FIG. 2, two camera modules 110-1 and 110-2 are shown, but the camera device 100 may include more camera modules 110.

Each of the camera modules 110 has a lens drive device 120, a lens 102, and an image sensor 108. In the specification, the lens drive devices 120 provided in the camera modules 110 are collectively referred to as a lens drive system 150. The lens drive system 150 controls the relative position between the image sensor 108 and the lens 102 for the lenses 102 provided corresponding respectively to the image sensors 108 in the camera device 100. The lens drive devices 120 are provided corresponding respectively to the lenses 102, and each drives the relative position of the corresponding lens 102.

The lens 102 focuses light from a subject onto the image sensor 108. The image sensor 108 outputs detection data according to the intensity of the received light. The image sensor 108 may have multiple light receiving elements disposed in a two-dimensional array. Each of the light receiving elements outputs an electrical signal according to the intensity of the received light. By combining the electrical signals, detection data indicating a two-dimensional image is generated. The image sensor 108 is, for example, a CMOS image sensor or a CCD image sensor, but is not limited thereto.

Image data is generated based on the detection data output by each of the image sensors 108. The generated image data may be displayed on the display device 204 as described above, and may be stored in the storage device 208. The camera device 100 controls the detection data of which of the image sensors 108 is used to generate image data according to the status information of the camera device 100.

The status information is, for example, information indicating an imaging magnification, an imaging mode, or the like specified by a user or the like. The imaging mode may include, for example, a normal imaging mode and a wide-angle imaging mode having different angles of view. The lens 102 and the camera module 110 to be used are determined by the imaging magnification or the imaging mode. The camera device 100 may use the detection data of the image sensor 108 in the camera module 110 corresponding to the status information as image data. The camera device 100 may generate image data by combining multiple pieces of detection data from two or more camera modules 110. The camera device 100 may further include a data selection unit that selects detection data according to the status information. In another example, the central control unit 202 may function as a data selection unit via the communication path 210.

The lens drive device 120 controls the relative position of the lens 102. The lens drive device 120 in each of the examples controls the relative position between the lens 102 and the image sensor 108 by moving the lens 102. However, the lens drive device 120 may move the image sensor 108, and may move both the lens 102 and the image sensor 108. In the specification, the relative position of the lens 102 with respect to the image sensor 108 may be simply referred to as a lens position or a position of the lens.

The lens drive device 120 may control the focal position of the lens by controlling the position of the lens in a direction parallel to an optical axis of the lens, and may control the position of the imaging range by controlling the position of the lens in a direction perpendicular to the optical axis of the lens. The lens drive device 120 may control the position of the lens 102 in response to an operation from a user or the like, and may automatically control the position of the lens 102 such as in autofocus or image stabilization.

The camera module 110 of the example further includes a drive element 106 and a driven element 104. The drive element 106 moves the lens 102 in response to control from the lens drive device 120. The drive element 106 may be provided for each of directions in which the lens 102 is moved. The drive element 106 of the example is an element such as a coil that generates a magnetic field, but is not limited thereto. One lens drive device 120 may be provided for multiple drive elements 106, or may be provided for each of the drive elements 106.

The driven element 104 is fixed to the lens 102 directly or indirectly via another member. The driven element 104 moves together with the lens 102 by the magnetic field or the like generated by the drive element 106. The driven element 104 of the example is, for example, a magnet, but is not limited thereto. In the case of moving the image sensor 108, the driven element 104 is fixed to the image sensor 108.

As described above, the detection data used for generating the image data is selected in response to the status information of the camera device 100. On the other hand, for example, in the case of sequentially changing the imaging magnification, the selected detection data may be switched in response to the imaging magnification. Even in such a case, in order to continuously generate the image data, the camera modules 110 other than the currently selected camera module 110 also operate to generate the detection data.

However, if the camera modules 110 operate equivalently, power consumption increases. The lens drive system 150 of the example changes the power consumption in at least one lens drive device 120 based on the status information of the camera device 100. For example, the power consumption of the lens drive device 120 in the camera modules 110 other than the currently selected camera module 110 is made smaller than the power consumption of the other lens drive devices 120. In this way, the power consumption of the lens drive system 150 can be reduced. At this time, the communication path 210 between the central control unit 202 and each of the lens drive devices 120 may maintain an active state. "Active state" or "active" indicates a state in which at least one of transmission and reception of information through the communication path 210 is probable. For example, a state in which communication through the communication path 210 is established between the central control unit 202 and the lens drive device 120 may be the active state.

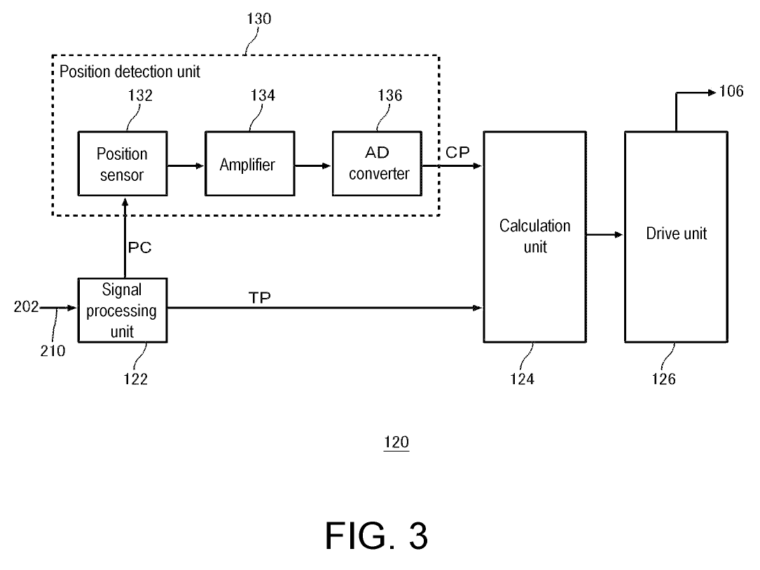

FIG. 3 is a diagram showing a configuration example of the lens drive device 120. The lens drive device 120 includes a position detection unit 130, a signal processing unit 122, a calculation unit 124, and a drive unit 126. The position detection unit 130, the signal processing unit 122, the calculation unit 124, and the drive unit 126 may be integrated and mounted on a single IC chip. The position detection unit 130 detects the current position of the corresponding lens 102 and outputs a current position signal CP. The corresponding lens 102 indicates the lens 102 to be controlled by the lens drive device 120. The position detection unit 130 may detect the position of the lens 102 by detecting the magnetic field from the magnet provided on the lens 102.

The signal processing unit 122 outputs a target position signal TP indicating the target position of the lens 102. The target position may be determined in response to an operation by a user or the like, and may be automatically calculated by the signal processing unit 122 or the central control unit 202 by an autofocus or image stabilization function or the like. The target position may be input to the signal processing unit 122 from the central control unit 202 or the like via the communication path 210.

The calculation unit 124 calculates the drive amount of the lens 102 based on the input current position signal CP and target position signal TP. The calculation unit 124 may calculate the drive amount indicating the direction of moving the lens 102 and the magnitude of movement from the difference between the current position and the target position of the lens 102. The calculation unit 124 may perform PID calculation as an example. The calculation unit 124 may use proportional gain, integral gain, differential gain, and the like as control parameters.

The drive unit 126 drives the lens 102 based on the drive amount input from the calculation unit 124. The drive unit 126 in the example controls each of the drive elements 106 in response to the drive amount. For example, the drive unit 126 drives the lens 102 by controlling the magnetic field generated by the drive element 106 by controlling the current or voltage applied to each of the drive elements 106.

The signal processing unit 122 outputs a power control signal PC that controls the power consumption of the position detection unit 130. The signal processing unit 122 of at least one lens drive device 120 changes the power consumption of the position detection unit 130 in response to the status information of the camera device 100. The signal processing unit 122 may make the power consumption of the corresponding position detection unit 130 smaller than the power consumption of other position detection units 130 in response to the status information of the camera device 100. For example, the power consumption of the position detection unit 130 of the camera module 110 that is not used for generating image data may be controlled to be smaller than the power consumption of the position detection unit 130 of the camera module 110 that is used for generating image data. By such control, the power consumption of the camera device 100 can be reduced. The central control unit 202 may generate the power control signal PC based on the status information and transmit the power control signal PC to each of the signal processing units 122 via the communication path 210. In another example, the central control unit 202 may transmit the status information to the signal processing unit 122 via the communication path 210, and the signal processing unit 122 may generate the power control signal PC based on the status information.

The signal processing unit 122 may reduce the power consumption of the position detection unit 130 by controlling the operation period of the position detection unit 130. The operation period of the position detection unit 130 refers to a period during which the position detection unit 130 is operating to generate the current position signal CP. The operation period of the position detection unit 130 may refer to a period during which drive power is supplied to the position detection unit 130. The signal processing unit 122 may reduce the power consumption of the position detection unit 130 by reducing the output frequency or update frequency of the current position signal CP in the position detection unit 130. At this time, the communication path 210 of the lens drive device 120 corresponding to the position detection unit 130 with reduced power consumption may be active. In addition, the drive unit 126 corresponding to the position detection unit 130 with reduced power consumption may be operated to be in a state capable of generating image data. In addition, the drive unit 126 may be operated to execute image stabilization.

In the case where the signal processing unit 122 makes the power consumption of the corresponding position detection unit 130 smaller than the power consumption of other position detection units 130, the power consumption of the corresponding drive unit 126 may be maintained. That is, power for controlling the position of the lens 102 may continue to be supplied to the drive unit 126.

For example, the calculation unit 124 and the drive unit 126 control the position of the lens 102 in response to the previous current position signal CP even during a period in which the position detection unit 130 does not newly detect the relative position of the lens 102 and the current position signal CP is not updated. In this case, power for generating a magnetic field or the like is supplied to the drive element 106. As a result, although a slight control error occurs due to the decrease in the detection frequency of the current position, the position of the lens 102 can be maintained approximately correctly. Therefore, even in the case where the camera module 110 used for generating image data is switched to the camera module 110, there is no need to significantly move the position of the lens 102, and appropriate image data can be generated without delay. Therefore, appropriate image data can be generated while reducing the power consumption of the camera device 100. In another example, when the signal processing unit 122 reduces the power consumption of the corresponding position detection unit 130 to be smaller than the power consumption of the rest of the position detection units 130, the power consumption of the corresponding drive unit 126 may also be reduced. This can further reduce the power consumption.

The position detection unit 130 of the example includes a position sensor 132, an amplifier 134, and an AD converter 136. The position sensor 132 detects the lens position of the lens 102. The position sensor 132 is, for example, a silicon Hall element, a compound Hall element, or a magnetoresistive element.

The amplifier 134 amplifies and outputs a signal of the lens position output by the position sensor 132. The amplifier 134 may be a buffer with an amplification factor of 1. The AD converter 136 converts a signal of the lens position detected by the position sensor 132 into digital data. The AD converter 136 outputs the current position signal CP obtained by converting a signal of the lens position into digital data.

The signal processing unit 122 may control the power consumption of at least one of the position sensor 132, the amplifier 134, and the AD converter 136 in response to the status information of the camera device 100. The signal processing unit 122 may control the power consumption in the position sensor 132 in response to the status information of the camera device 100. For example, the signal processing unit 122 controls the frequency at which the position sensor 132 outputs or updates a signal indicating the lens position. The signal processing unit 122 may supply power to the position sensor 132 at a timing when the position sensor 132 should output a signal of the lens position. The signal processing unit 122 may control a period during which power for causing the position sensor 132 to detect the position is supplied. The AD converter 136 may operate each time the position sensor 132 outputs a signal of the lens position and convert the signal into digital data.

The signal processing unit 122 may control the power consumption of the AD converter 136 in response to the status information of the camera device 100. The power consumption of the AD converter 136 can be controlled by adjusting the length of a period during which the AD converter 136 is operating to perform AD conversion. Even in the case of shortening the operation period of the AD converter 136, the period during which the position sensor 132 detects the lens position may be maintained, or may be shortened similarly to the operation period of the AD converter 136.

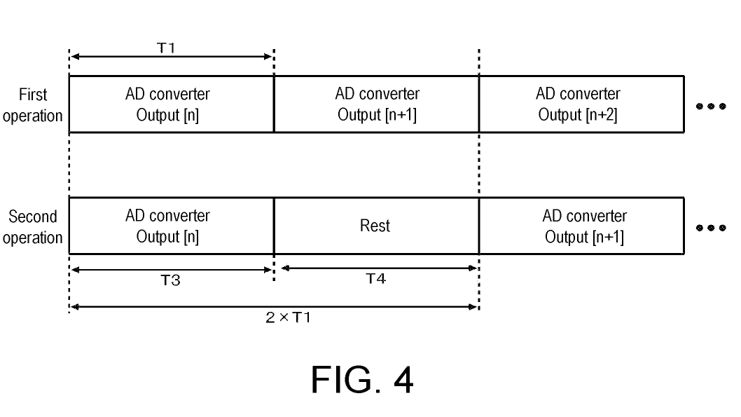

FIG. 4 is a diagram showing an operation example of the position detection unit 130. FIG. 4 shows two operation modes with different power consumption. The first operation mode is a mode with greater power consumption than the second operation mode. In each of the operation modes, the position detection unit 130 sequentially outputs multiple current position signals CP. In FIG. 4, each of outputs [k (where k is n, n+1, n+2, ...)] of the AD converter 136 is shown as the current position signal CP. Each time the value of k in each of the outputs increases, the current position signal CP is updated in response to the lens position detected by the position sensor 132.

In FIG. 4, the period indicated by an output [k] of the AD converter 136 is a conversion period during which the AD converter 136 is operating to generate the current position signal CP. For example, a period T1 in the first operation mode and a period T3 in the second operation mode are conversion periods. Within the conversion period, at least a portion of the AD converter 136 is operating in response to the operation clock. For example, within the conversion period, the AD converter 136 may be performing at least one of a sampling operation for sampling the amplitude value of an input analog signal, a quantization operation for generating discrete values in response to the sampled result, and an encoding operation for converting the discrete values into binary digital signals and outputting the binary digital signals.

In FIG. 4, the period indicated as rest is a rest period during which the AD converter 136 is not operating to generate the current position signal CP. For example, a period T4 in the second operation mode is a rest period. During the rest period, for example, the AD converter 136 may not be performing any of the above-described sampling operation, quantization operation, and encoding operation. The conversion period may be a period during which the AD converter 136 is converting the current position signal CP in response to the lens position into a digital value. The rest period may be a period during which the AD converter 136 is not outputting the current position signal CP in response to the lens position. During the rest period, the output of the AD converter 136 may maintain the value of the previous current position signal CP, or may be a constant value (for example, 0). During the rest period, the position sensor 132 may or may not be detecting the lens position.

In the example, the signal processing unit 122 reduces the power consumption of the position detection unit 130 by reducing the total time during which the position detection unit 130 operates to convert the current position signal CP within a unit time. In the example of FIG. 4, the position detection unit 130 operates during the conversion period T1 to generate one current position signal CP. In the position detection unit 130 of the example, in the first operation mode, the conversion periods for the respective current position signals CP are continuous. Therefore, in the first operation mode, the total time during which the position detection unit 130 is operating within a unit time (for example, 2×T1) is 2×T1.

On the other hand, in the second operation mode, the position detection unit 130 operates to output one current position signal CP during a portion of the conversion period T3 within the same unit time (2×T1), and rests during the remaining rest period T4. Therefore, in the second operation mode, the total time during which the position detection unit 130 operates within a unit time is T3, which is smaller than the total time 2×T1 of the first operation mode.

By such processing, the power consumption of the position detection unit 130 can be controlled. In addition, the signal processing unit 122 may reduce the power consumption of the position detection unit 130 by increasing the rest period during which the position detection unit 130 does not operate to output the current position signal CP within a unit time. In the example of FIG. 4, the rest period within a unit time (2×T1) in the first operation mode is 0, but the rest period within a unit time in the second operation mode is T4. The rest period in the first operation mode may not be 0. The rest period T4 within a unit time in the second operation mode may be half or more of the unit time (2×T1).

FIG. 4 shows a continuous operation mode as the first operation mode, and shows an intermittent operation mode as the second operation mode. In the continuous operation mode, the conversion periods T1 for multiple current position signals CP are continuous. That is, in the continuous operation mode, there is no rest period between the conversion periods T1 of two current position signals CP. For example, when the position detection unit 130 such as the AD converter 136 is operating according to the cycle of the operation clock, the rest period may be a period longer than one cycle of the operation clock. In the continuous operation mode, there is no rest period longer than one cycle of the operation clock between two conversion periods T1. In the continuous operation mode, the processing of the sampling operation, quantization operation, and encoding operation for two current position signals CP may be performed continuously without a rest period in between.

In the intermittent operation mode, the position detection unit 130 alternately repeats the conversion period T3 and the rest period T4. The rest period T4 is longer than one cycle of the operation clock described above. The length of the rest period T4 may be 25% or more of the length of the conversion period T3, and may be 50% or more. In the example of FIG. 4, the signal processing unit 122 reduces power consumption by operating the position detection unit 130 intermittently.

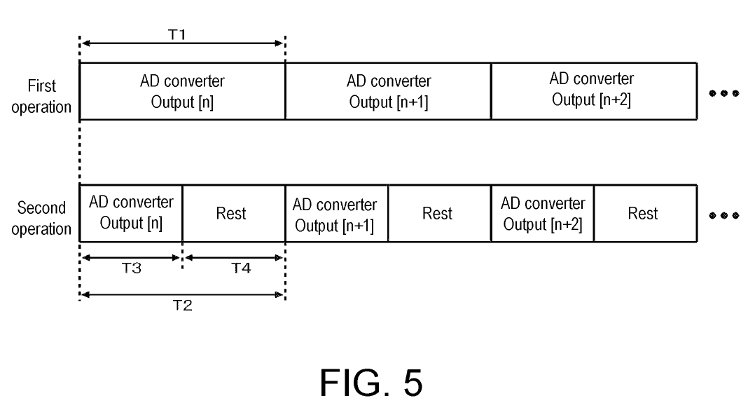

FIG. 5 is a diagram showing another operation example of the position detection unit 130. The operation of the position detection unit 130 in the first operation mode is the same as the example of FIG. 4. The signal processing unit 122 of the example reduces the power consumption of the position detection unit 130 by shortening the conversion period T3 during which the position detection unit 130 operates to output the current position signal CP of one time in the second operation mode.

In the example as well, the position detection unit 130 in the second operation mode performs an intermittent operation by alternately repeating the conversion period T3 and the rest period T4. A repetition period T2, which is the sum of the conversion period T3 of one time and the rest period T4 of one time in the intermittent operation, may be equal to or less than the conversion period T1 for outputting the current position signal of one time in the continuous operation. The repetition period T2 may be the same as the conversion period T1. In this case, the cycle at which the current position signal CP is updated is the same in the continuous operation mode and the intermittent operation mode. The conversion period T3 may be half or less of the conversion period T1. The repetition period T2 may be shorter than the conversion period T1. The repetition period T2 may be half or less of the conversion period T1.

The frequency at which the conversion period T3 and the rest period T4 are repeated in the intermittent operation mode is defined as the repetition frequency. The repetition frequency is the reciprocal of the repetition period (for example, T2). In the continuous operation mode, the reciprocal of the conversion period T1 is defined as the repetition frequency. In the example shown in FIG. 4, the repetition frequency in the intermittent operation mode is smaller than the repetition frequency in the continuous operation mode. Since the repetition frequency corresponds to the control frequency of the lens 102, when the repetition frequency becomes smaller, the control frequency of the lens 102 also becomes smaller. When the control frequency of the lens 102 becomes smaller, the control sound of the lens 102 may become audible to a user or the like. From the viewpoint of the calculation unit 124, the situation in which the position detection unit 130 is operating based on the repetition frequency is a state in which a signal corresponding to the detected actual position information of the lens 102 (referred to as a real signal) and a signal corresponding to the situation in which the position detection unit 130 has stopped operating (referred to as a dummy signal) are alternately input. From the viewpoint of the entire system, the state can be regarded as equivalent to an operation in which the calculation unit 124 and the drive unit 126 eliminate the difference between the real signal and the dummy signal. The operation becomes a cause of generation of the control sound of the lens 102. Therefore, by controlling the band of the repetition frequency, the generation band of the control sound derived from the real signal and the dummy signal can also be controlled.

The signal processing unit 122 may adjust at least one of the conversion period T3 and the rest period T4 so that the repetition frequency in the intermittent operation is equal to or higher than a preset set frequency. For example, as shown in FIG. 5, by setting the conversion period T3 and the rest period T4 to be short, a decrease in the repetition frequency can be suppressed. The set frequency may be equal to or higher than the upper limit of the human audible frequency. The range of the audible frequency may be 20 Hz or higher and 20 kHz or lower. The upper limit in this case is 20 kHz. The set frequency may be 10 kHz or higher. The set frequency may be 16 kHz or higher, or may be 20 kHz or higher. By such control, it is probable to suppress the control sound of the lens 102 from being heard by a user or the like.

The repetition frequency in the intermittent operation may be equal to or higher than the calculation frequency at which the calculation unit 124 calculates the lens drive amount. The calculation frequency in the calculation unit 124 refers to the frequency at which the calculation unit 124 updates the lens drive amount. By updating the lens drive amount, the drive unit 126 controls the position of the lens 102. Therefore, the calculation frequency in the calculation unit 124 corresponds to the control frequency for controlling the lens 102. In order to prevent the control sound of the lens 102 from being generated in the audible band, the calculation frequency in the calculation unit 124 may be set higher than the upper limit of the audible frequency. By setting the repetition frequency in the position detection unit 130 to be equal to or higher than the calculation frequency, the repetition frequency can be set higher than the audible frequency.

The conversion period T3 can be shortened by reducing the accuracy of AD conversion in the AD converter 136. For example, when the AD converter 136 is an oversampling type or ΔΣ modulation type AD converter 136, the output rate of the AD converter 136 can be increased by lowering the oversampling ratio. The output rate is indicated by, for example, the reciprocal of the conversion period T3. In the oversampling type AD converter 136, the lens position signal is sampled with a sampling number significantly larger than the sampling number corresponding to the Nyquist rate. The larger the sampling number (the higher the oversampling ratio), the higher the resolution of the output current position signal. The resolution of a digital signal is indicated by the number of bits corresponding to a value larger than the quantization error component.

On the other hand, the larger the sampling number, the longer the time required to generate the current position signal of one time (conversion period T3). When operating the position detection unit 130 in the intermittent operation, the signal processing unit 122 may lower the oversampling ratio of the AD converter 136 and increase the output rate compared to the case of the continuous operation. When operating the position detection unit 130 in the intermittent operation, the signal processing unit 122 may lower the resolution of the AD converter 136 and increase the output rate compared to the case of the continuous operation.

The resolution of the AD converter 136 can be adjusted by the oversampling ratio described above, but may be adjusted by other methods. The AD converter 136 may be a Nyquist type AD converter. In a Nyquist type AD converter, the input signal is sampled at the Nyquist frequency. In the Nyquist type AD converter 136 as well, by reducing the number of times the input signal is sampled to generate one current position signal, the resolution of the AD converter 136 can be lowered and the output rate can be increased.

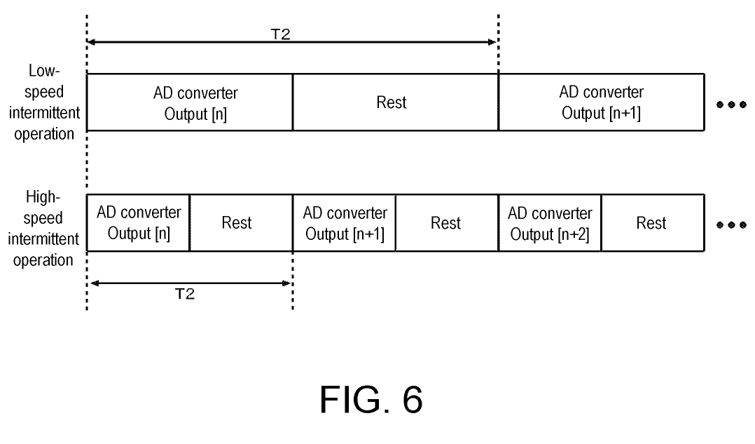

FIG. 6 is a diagram showing another operation example of the position detection unit 130. The position detection unit 130 of the example has a low-speed intermittent operation mode and a high-speed intermittent operation mode as the second operation mode. In the low-speed intermittent operation mode, the repetition frequency (1/T2) is smaller than the set frequency described above. In the high-speed intermittent operation mode, the repetition frequency (1/T2) is equal to or higher than the set frequency described above. The set frequency is, for example, the upper limit of the audible frequency. The low-speed intermittent operation mode may be the same as the second operation mode in FIG. 4, and the high-speed intermittent operation mode may be the same as the second operation mode in FIG. 5.

The signal processing unit 122 may switch between the high-speed intermittent operation mode and the low-speed intermittent operation mode in response to an external signal. The external signal is a signal input from outside the signal processing unit 122. The external signal may be input from the central control unit 202 via the communication path 210. The external signal may be generated, for example, in response to an operation by a user or the like. For example, in the case where the user or the like does not mind noise, the low-speed intermittent operation mode may be selected. Alternatively, the low-speed intermittent operation mode may be implemented to determine by sound whether the intermittent operation mode is functioning.

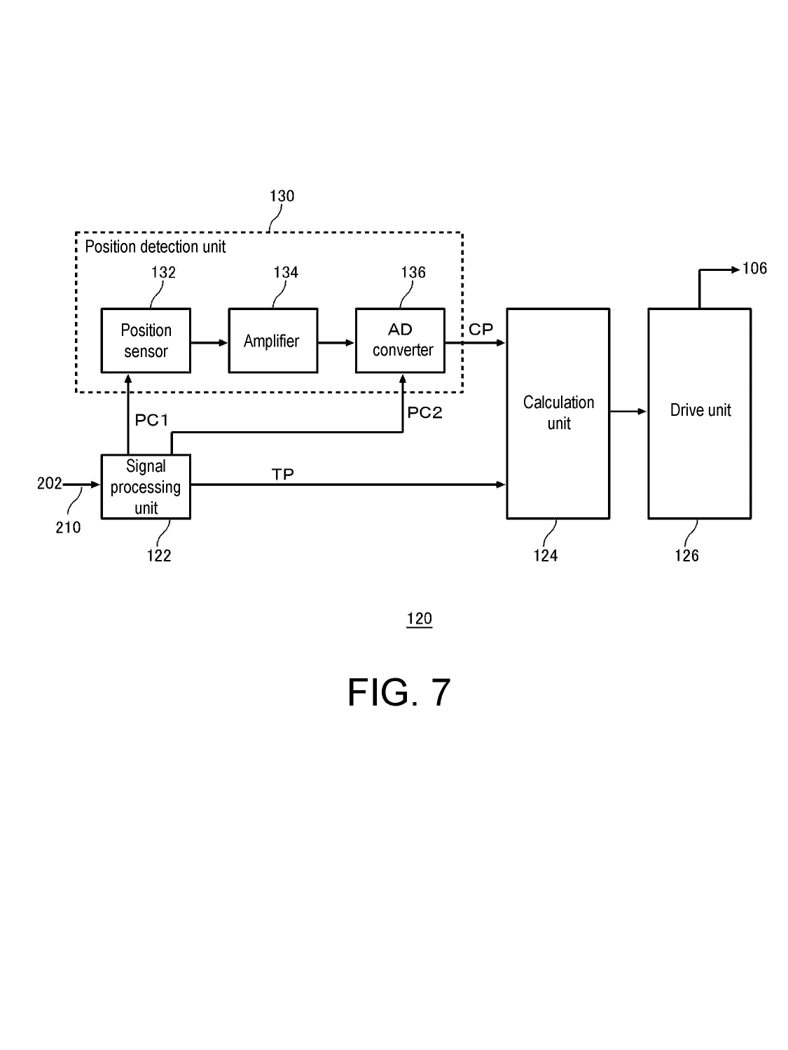

FIG. 7 is a diagram showing a control example of the position detection unit 130. The signal processing unit 122 of the example controls power consumption by adjusting the conversion accuracy in the AD converter 136, as described above. The signal processing unit 122 may generate a power control signal PC2 that adjusts at least one of the oversampling ratio, sampling number, resolution, and output rate in the AD converter 136. In the example as well, the signal processing unit 122 may generate a power control signal PC1 that controls the power consumption in the position sensor 132.

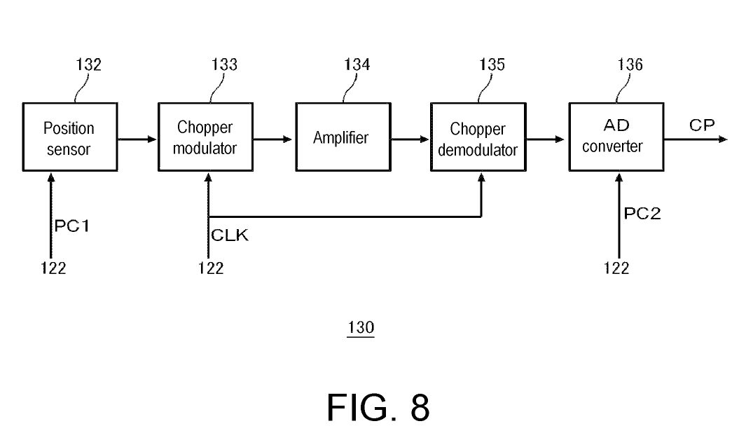

FIG. 8 is a diagram showing another configuration example of the position detection unit 130. The position detection unit 130 of the example further includes a chopper modulator 133 and a chopper demodulator 135 in addition to the configuration shown in FIG. 3. Moreover, the amplifier 134 of the example is a differential amplifier.

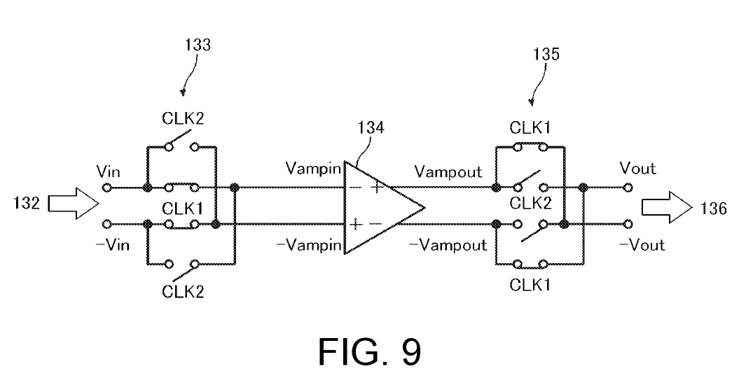

FIG. 9 is a diagram showing a configuration example of the chopper modulator 133, the amplifier 134, and the chopper demodulator 135. The position sensor 132 of the example detects the lens position and outputs differential detection signals (Vin, -Vin).

The chopper modulator 133 modulates the polarity of the differential detection signals (Vin, -Vin) according to the chopping frequency. The chopper modulator 133 of the example outputs, as a output signal Vn, the detection signal Vin during a period when a chopping clock CLK1 is H logic and a chopping clock CLK2 is L logic, and outputs the inverted detection signal -Vin during a period when the chopping clock CLK1 is L logic and the chopping clock CLK2 is H logic. The chopping clock CLK2 is a clock with the waveform of the chopping clock CLK1 inverted. The chopper modulator 133 outputs, as a output signal -Vn, the detection signal Vin during a period when the chopping clock CLK1 is L logic and the chopping clock CLK2 is H logic, and outputs the inverted detection signal -Vin during a period when the chopping clock CLK1 is H logic and the chopping clock CLK2 is L logic.

The amplifier 134 amplifies differential signals (Vampin, -Vampin) output by the chopper modulator 133 at an amplification factor of 1 or more, and outputs differential signals (Vampout, -Vampout). The chopper demodulator 135 demodulates the output of the amplifier 134 according to the chopping frequency. The chopper demodulator 135 of the example outputs, as a detection signal Vout, the differential signal -Vampout during a period when the chopping clock CLK1 is H logic and the chopping clock CLK2 is L logic, and outputs the differential signal Vampout during a period when the chopping clock CLK1 is L logic and the chopping clock CLK2 is H logic. The chopper demodulator 135 outputs, as the detection signal -Vout, the differential signal -Vampout during a period when the chopping clock CLK1 is L logic and the chopping clock CLK2 is H logic, and outputs the differential signal Vampout during a period when the chopping clock CLK1 is H logic and the chopping clock CLK2 is L logic. The AD converter 136 of the example converts the differential detection signals (Vout, -Vout) output by the chopper demodulator 135 into digital data.

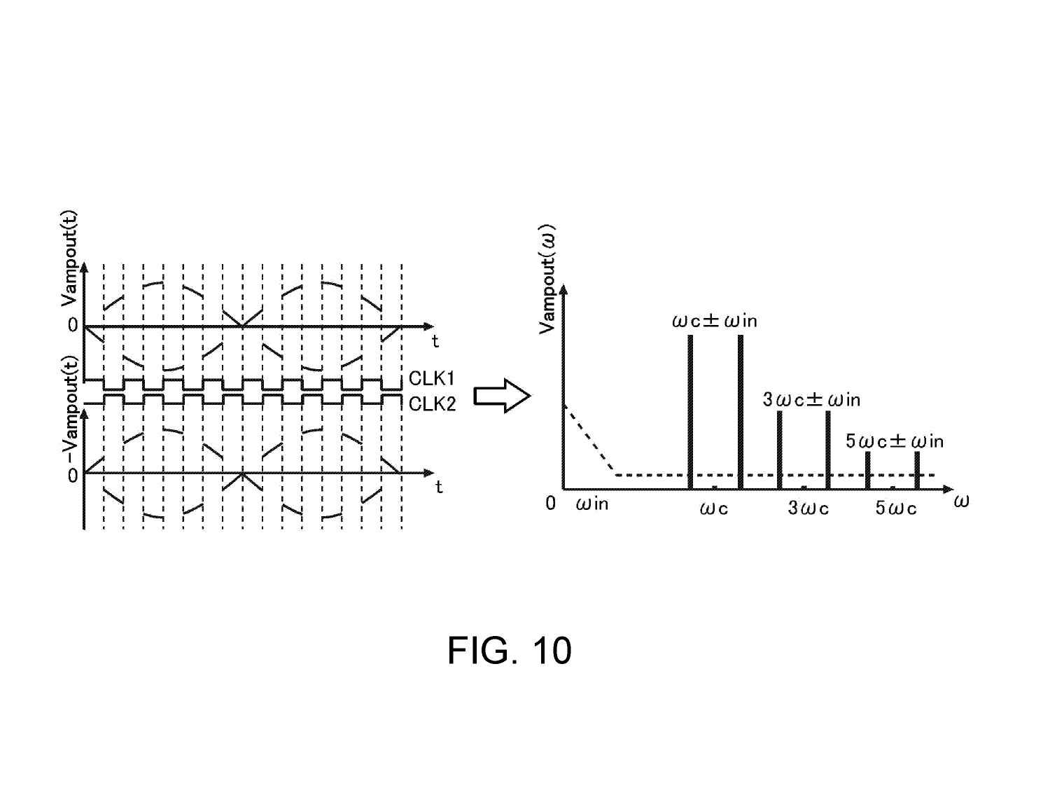

FIG. 10 is a diagram showing an example of time waveforms of the differential signals (Vampout, -Vampout) and a frequency spectrum. The differential signals (Vampout, -Vampout) are signals obtained by amplifying the differential signals (Vampin, -Vampin). At this time, the offset and noise component of the amplifier are also amplified.

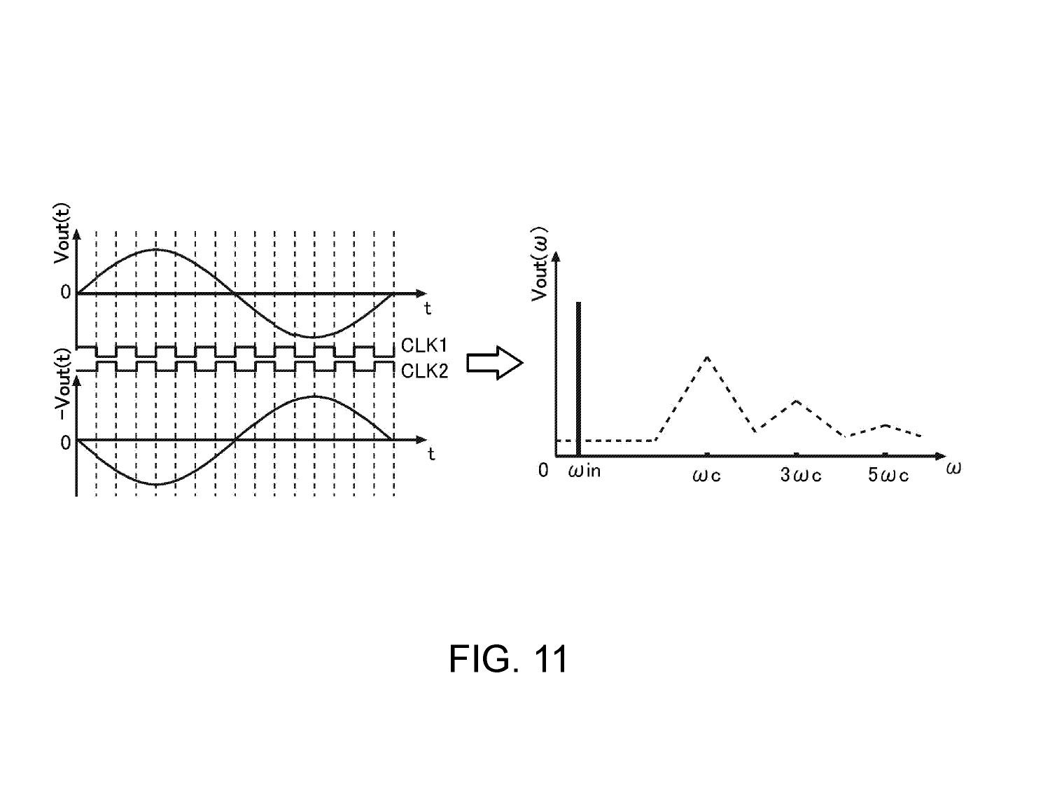

FIG. 11 is a diagram showing an example of time waveforms of the detection signals (Vout, -Vout) and a frequency spectrum. The detection signals (Vout, -Vout) correspond to signals obtained by amplifying the detection signals (Vin, -Vin). Therefore, the detection signals (Vout, -Vout) have a peak at a frequency ωin. On the other hand, the noise component is moved to a high frequency band according to chopping frequency ωc. Therefore, by using a low-pass filter, the noise component moved to the high frequency band can be removed, and the frequency component of the detection signals (Vout, -Vout) can be extracted.

As described above, the signal processing unit 122 may control the output rate of the AD converter 136 to control the power consumption of the position detection unit 130. In this case, the variation amount of the chopping frequency before and after the output rate of the AD converter 136 varies may be smaller than the variation amount of the output rate.

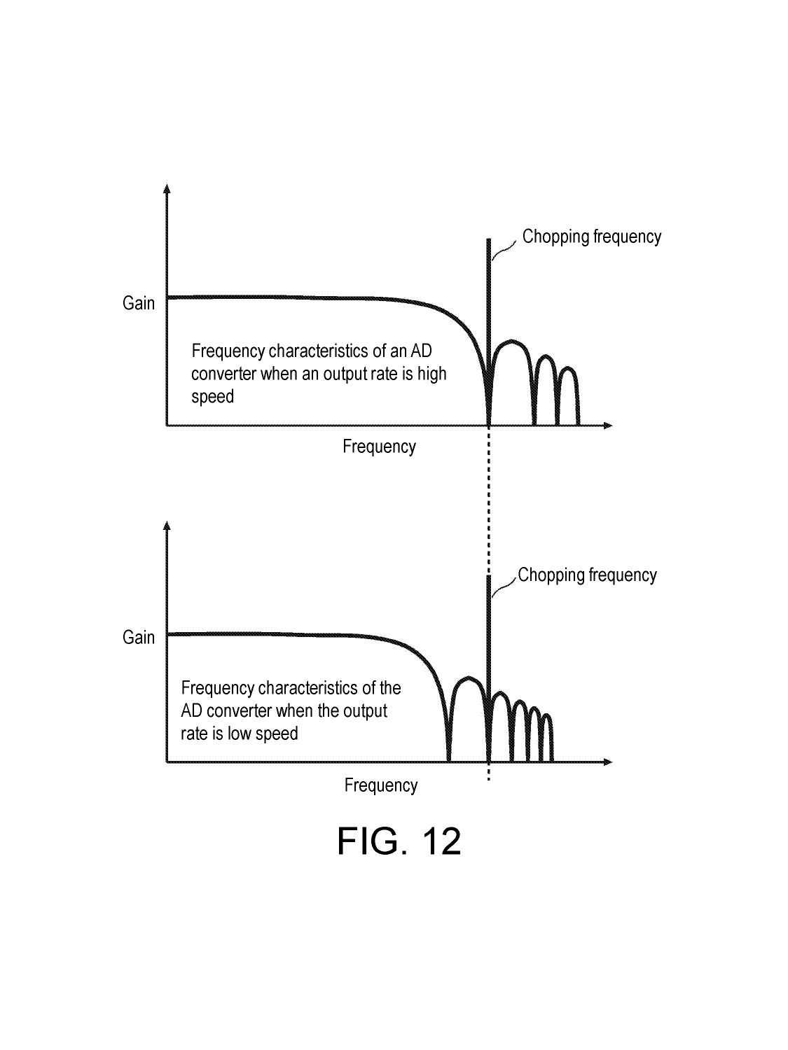

FIG. 12 is a diagram showing the frequency characteristics of the AD converter 136 and the chopping frequency when the output rate of the AD converter 136 is high speed or low speed. The chopping frequency may be maintained constant before and after the output rate of the AD converter 136 varies. By such control, even when the power consumption of the position detection unit 130 is reduced, the chopper modulation frequency is maintained, so that the offset of the detection signal and the noise component in the low frequency band can be accurately removed.

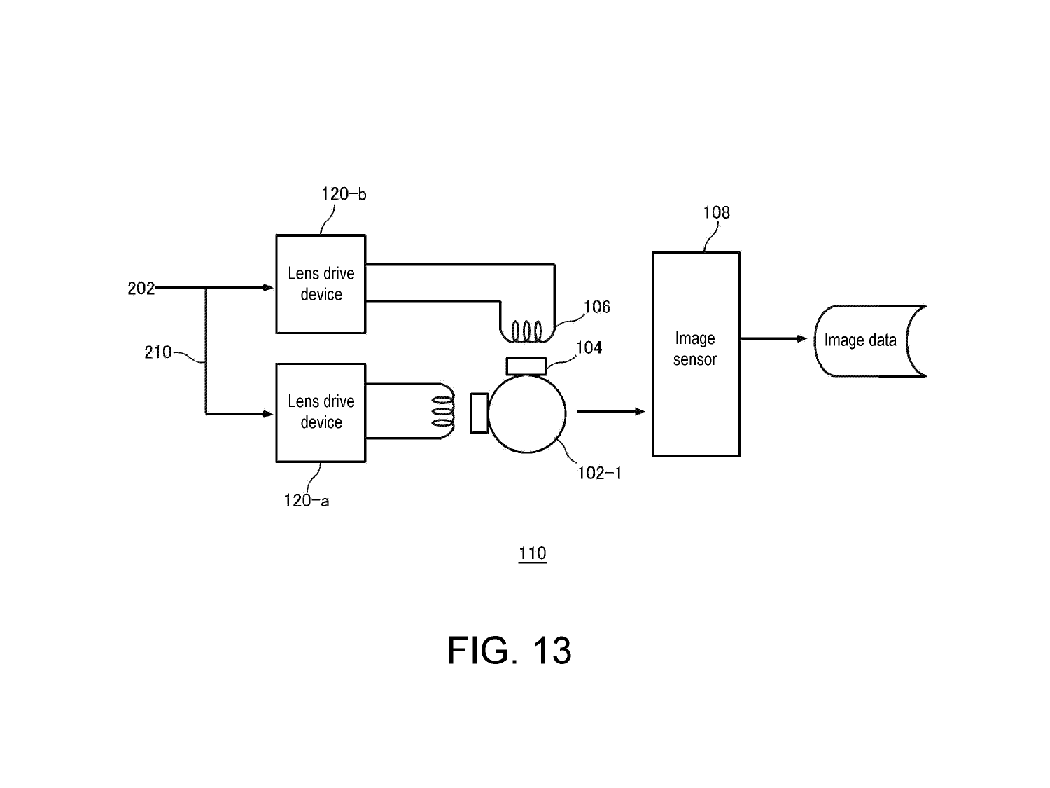

FIG. 13 is a diagram showing another configuration example of the camera module 110. The camera module 110 of the example includes a first lens drive device 120-a and a second lens drive device 120-b that drive a common lens 102. In the camera module 110 of the example, the lens drive device 120 may be provided for each of the drive elements 106. Other structures are similar to the example of FIG. 2. Moreover, the structure of each of the lens drive devices 120 is similar to any of the examples described in FIG. 2 to FIG. 12.

Also in the example, the power consumption of either one of the first lens drive device 120-a and the second lens drive device 120-b may be controlled to be smaller than the power consumption of the other according to the status information of the camera device 100. For example, in a state where the camera module 110 is not used for generating image data, the signal processing unit 122 may reduce the power consumption of either one of the first lens drive device 120-a and the second lens drive device 120-b. In another example, the power consumption of both the first lens drive device 120-a and the second lens drive device 120-b may be reduced.

The central control unit 202 or the like may determine which of the first lens drive device 120-a and the second lens drive device 120-b is to have the power consumption thereof reduced according to the status information. The status information of the example may include detection data generated by the image sensor 108 when both the first lens drive device 120-a and the second lens drive device 120-b are operated with low power consumption. The central control unit 202 may determine, based on the detection data, which of the first lens drive device 120-a and the second lens drive device 120-b is to be operated with low power consumption in the future. For example, the central control unit 202 or the like may detect in which direction in the image the noise included in the image of the detection data, which has increased due to operating the lens drive device 120 with low power consumption, continuously exists. The central control unit 202 or the like may reduce the power consumption of the lens drive device 120 that controls the lens 102 in a direction different from the direction of the noise. In this way, it is probable to suppress an increase in noise included in the image of the detection data while reducing the power consumption in the camera module 110.

In addition, as a modified example of the above-described embodiment, in the lens drive system 150, the calculation unit 124 may be mounted on the central control unit 202. In this case, each of the lens drive devices 120 may have the signal processing unit 122, the drive unit 126, and the position detection unit 130. The modified example is a lens drive system that controls the relative position of lenses with respect to image sensors for multiple lenses (for example, the lens 102-1 and lens 102-2) provided corresponding to multiple image sensors (for example, the image sensor 108-1 and image sensor 108-2) in the camera device 100, and may be the same as other embodiments described in the specification with respect to including multiple lens drive devices (for example, the lens drive device 120-1, and lens drive device 120-2) provided corresponding to the lenses and each controlling the relative position of the corresponding lens.

Moreover, each of the lens drive devices 120 includes the position detection unit 130 that detects the current relative position of the corresponding lens 102, the drive unit 126 that drives at least one of the lens 102 and the image sensor 108 based on the drive amount, and the signal processing unit 122 that outputs a power control signal for controlling the power consumption of the position detection unit 130. Furthermore, each of the image sensors 108 outputs detection data, the communication path 210 of the lens drive device 120 is active, the detection data of which of the image sensors 108 is used to generate image data is controlled according to the status information of the camera device, and the signal processing unit 122 of at least one lens drive device 120 changes the power consumption of the position detection unit 130 according to the status information, which may be the same as other embodiments described in the specification.

In addition, in the modified example, the central control unit 202 acquires the current position signal from each of the lens drive devices 120, derives the drive amount of at least one of the lens 102 and the image sensor 108 based on the current position signal and the target position signal, and transmits the derived drive amount to each of the lens drive devices 120. Each of the lens drive devices 120 receives the drive amount for itself via the communication path 210, and the drive unit 126 operates according to the received drive amount. The communication path 210 is preferably a communication bus compatible with I2C, or a communication standard compatible with higher-speed communication, for example, I3C (Improved Inter-Integrated Circuit).

Note that the calculation unit 124 in the modified example may be realized as software executed by the central control unit 202, or may be mounted as an IC chip externally attached to the central control unit 202. In addition, in the modified example, with respect to each of the lens drive devices 120, the signal processing unit 122, the drive unit 126, and the position detection unit 130 may be integrated on a single IC chip.

The disclosure has been described above using the embodiments, but the technical scope of the disclosure is not limited to the scope described in the above embodiments. It is apparent to those skilled in the art that various changes or improvements can be added to the above embodiments. It is apparent from the description of the claims that forms with such changes or improvements added can also be included in the technical scope of the disclosure.

It should be noted that the execution order of each process such as operations, procedures, steps, and stages in the devices, systems, programs, and methods shown in the claims, specification, and drawings can be realized in any order unless specifically indicated as "before" or "prior to", and unless the output of a previous process is used in a subsequent process. Even if the operation flows in the claims, specification, and drawings are described using "first," "next," and the like for convenience, this does not mean that implementation in this order is mandatory.

What is claimed is:

1. A lens drive system for controlling a relative position of a lens with respect to an image sensor for a plurality of lenses provided corresponding to a plurality of image sensors in a camera device, the lens drive system comprising:
a plurality of lens drive devices, provided corresponding to the plurality of lenses, and each controlling the relative position of a corresponding lens,
each of the lens drive devices comprising:
a position detection unit that detects a current relative position of the corresponding lens;
a calculation unit that calculates a drive amount of at least one of the lens and the image sensor based on a current position signal that is an output of the position detection unit and an input target position signal;
a drive unit that drives at least one of the lens and the image sensor based on the drive amount; and
a signal processing unit that outputs a power control signal for controlling power consumption of the position detection unit,
each of the image sensors outputting detection data, a communication path of the lens drive device being active, and the detection data of which of the image sensors being used to generate image data is controlled according to status information of the camera device, and
the signal processing unit of at least one of the lens drive devices changing power consumption of the position detection unit according to the status information.

2. The lens drive system according to claim 1, wherein
the signal processing unit, according to the status information, makes power consumption of the corresponding position detection unit smaller than power consumption of the rest of the position detection units, but operates the drive unit to make a state capable of generating image data.

3. The lens drive system according to claim 2, wherein
the signal processing unit, according to the status information, makes power consumption of the corresponding position detection unit smaller than power consumption of the rest of the position detection units, but operates the drive unit to execute image stabilization.

4. The lens drive system according to claim 2, wherein
when the signal processing unit makes power consumption of the corresponding position detection unit smaller than power consumption of the rest of the position detection units, power consumption of the corresponding drive unit is maintained.

5. The lens drive system according to claim 2, wherein
when the signal processing unit makes power consumption of the corresponding position detection unit smaller than power consumption of the rest of the position detection units, power consumption of the corresponding drive unit is also made smaller.

6. The lens drive system according to claim 2, wherein
the signal processing unit reduces power consumption of the position detection unit by reducing a total time during which the position detection unit operates to output the current position signal within a unit time.

7. The lens drive system according to claim 2, wherein
the signal processing unit reduces power consumption of the position detection unit by increasing a rest period during which the position detection unit does not perform an operation for outputting the current position signal within a unit time.

8. The lens drive system according to claim 6, wherein
the signal processing unit reduces power consumption of the position detection unit by shortening a conversion period during which the position detection unit operates to output the current position signal of one time.

9. The lens drive system according to claim 2, wherein
the plurality of lens drive devices comprise a first lens drive device and a second lens drive device that control the relative position of a common lens, and
according to the status information, power consumption of one of the first lens drive device and the second lens drive device is controlled to be smaller than power consumption of the other.

10. The lens drive system according to claim 1, wherein
the position detection unit is capable of a continuous operation in which conversion periods during which the position detection unit operates to output the current position signal are continuous, and an intermittent operation in which a rest period during which the position detection unit is not operating to output the current position signal and the conversion period are repeated, and
the signal processing unit reduces power consumption by causing the position detection unit to perform the intermittent operation.

11. The lens drive system according to claim 10, wherein
a repetition period obtained by adding the conversion period of one time and the rest period of one time in the intermittent operation is equal to or less than a period for outputting the current position signal of one time in the continuous operation.

12. The lens drive system according to claim 11, wherein
the signal processing unit adjusts at least one of the conversion period and the rest period so that a repetition frequency at which the conversion period and the rest period are repeated in the intermittent operation is equal to or higher than a preset set frequency.

13. The lens drive system according to claim 12, wherein
the set frequency is equal to or higher than an upper limit of an audible frequency.

14. The lens drive system according to claim 12, wherein
the set frequency is 10 kHz or higher.

15. The lens drive system according to claim 10, wherein
the position detection unit comprises:
a position sensor that detects the relative position; and
an AD converter that converts the relative position into digital data, and
when operating the position detection unit in the intermittent operation, the signal processing unit lowers an oversampling ratio of the AD converter and increases an output rate compared to a case of the continuous operation.

16. The lens drive system according to claim 10, wherein
the position detection unit comprises:
a position sensor that detects the relative position; and
an AD converter that converts the relative position into digital data, and
when operating the position detection unit in the intermittent operation, the signal processing unit lowers resolution of the AD converter and increases an output rate compared to a case of the continuous operation.

17. The lens drive system according to claim 10, wherein
the position detection unit comprises:
a position sensor that detects the relative position and outputs a differential detection signal;
a chopper modulator that modulates a polarity of the differential detection signal according to a chopping frequency;
a differential amplifier that amplifies and outputs an output of the chopper modulator;
a chopper demodulator that demodulates an output of the differential amplifier according to the chopping frequency; and
an AD converter that converts the detection signal output by the chopper demodulator into digital data,
the signal processing unit controls power consumption of the position detection unit by controlling an output rate of the AD converter, and
a variation amount of the chopping frequency before and after the output rate of the AD converter varies is smaller than a variation amount of the output rate.

18. The lens drive system according to claim 17, wherein
the chopping frequency is maintained constant before and after the output rate of the AD converter varies.

19. The lens drive system according to claim 10, wherein
a repetition frequency at which the conversion period and the rest period are repeated in the intermittent operation is equal to or higher than a calculation frequency at which the calculation unit calculates the drive amount of the lens.

20. The lens drive system according to claim 10, wherein
the position detection unit has a high-speed intermittent mode in which a repetition frequency at which the conversion period and the rest period are repeated in the intermittent operation is equal to or higher than an audible frequency, and a low-speed intermittent mode in which the repetition frequency is smaller than the audible frequency, and
the signal processing unit switches between the high-speed intermittent mode and the low-speed intermittent mode according to an external signal.

21. A portable device, provided with a camera device, wherein
the camera device comprises:
a plurality of image sensors;
a plurality of lenses provided corresponding to the plurality of image sensors; and
a lens drive system that controls a relative position of a lens with respect to an image sensor,
each of the lens drive devices comprises:
a position detection unit that detects a current relative position of a corresponding lens;
a calculation unit that calculates a drive amount of at least one of the lens and the image sensor based on a current position signal that is an output of the position detection unit and an input target position signal;
a drive unit that drives at least one of the lens and the image sensor based on the drive amount; and
a signal processing unit that outputs a power control signal for controlling power consumption of the position detection unit,
each of the image sensors outputs detection data, a communication path of the lens drive device is active, and the detection data of which of the image sensors is used to generate image data is controlled according to status information of the camera device, and
the signal processing unit of at least one of the lens drive devices changes power consumption of the position detection unit according to the status information.

22. The portable device according to claim 21, further comprising:
a central control unit, controlling each of the signal processing units based on the status information.
